(19) United States
(12) Patent Application Publication
(10) Pub. No.: US 2004/0220892 A1
(43) Pub. Date: Nov. 4, 2004

(54) Learning bayesian network classifiers using labeled and unlabeled data

(76) Inventors: Ira Cohen, Urbana, IL (US); Fabio G. Cozman, Boqueirao Santos (BR); Alexandre Bronstein, Palo Alto, CA (US); Marsha Prescott Duro, Los Altos Hills, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,463

(22) Filed: Apr. 29, 2003

(51) Int. Cl. G06E 1/00; G06E 3/00; G06G 7/00; G06F 15/18

(52) U.S. Cl. 706/20

(57) ABSTRACT

A method that yields more accurate Bayesian network classifiers when learning from unlabeled data in combination with labeled data includes learning a set of parameters for a structure of a classifier using a set of labeled data and learning a set of parameters for the structure using the labeled data and a set of unlabeled data and then modifying the structure if the parameters based on the labeled and unlabeled data leads to less accuracy in the classifier in comparison to the parameters based on the labeled data only. The present technique enable an increase in the accuracy of a statistically learned Bayesian network classifier when unlabeled data are available and reduces the likelihood of degrading the accuracy of the Bayesian network classifier when using unlabeled data.

### BACKGROUND OF THE INVENTION

1. Field of Invention

The present invention pertains to the field of Bayesian network classifiers. More particularly, this invention relates to learning Bayesian network classifiers using labeled and unlabeled data.

2. Art Background

Bayesian network classifiers may be employed in a wide variety of applications. Examples of applications of Bayesian network classifiers include diagnostic systems, decision making systems, event predictors, etc.

A typical Bayesian network classifier may be represented as a graph structure having a set of nodes and interconnecting arcs that define parent-child relationships among the nodes. A Bayesian network classifier usually includes a set of Bayesian network parameters which are associated with the nodes of the graph structure. The Bayesian network parameters usually specify the probabilities that each child node in the graph structure is in a particular state given that its parent nodes in the graph structure are in a particular state. Typically, the nodes of a Bayesian network classifier are associated with variables of an underlying application and the Bayesian network parameters indicate the strength of dependencies among the variables. Typically, the variables of a Bayesian network classifier include a set of features and a classification result.

The process of generating a Bayesian network classifier usually includes determining a structure of nodes and interconnecting arcs and then learning the Bayesian network parameters for the structure. The Bayesian network parameters are usually learned using a set of data that pertains to an application for which the classifier is being designed. The data that may be used to learn Bayesian network parameters may include labeled data and/or unlabeled data. Labeled data may be defined as a set of values for the features for which a classification result is known. The classification result is usually referred to as a label. Unlabeled data may be defined as a set of values for the features for which a classification result is not known.

Prior methods for learning Bayesian network parameters may use only labeled data. Unfortunately, labeled data are often difficult and/or expensive to obtain. Moreover, labeled data are usually required in large quantities to yield an accurate Bayesian network classifier which renders the task of acquiring labeled data even more daunting.

Prior methods for learning Bayesian network parameters may use only unlabeled data. Unfortunately, methods for learning from unlabeled data are usually computationally expensive and may not yield an accurate Bayesian network classifier.

Prior methods for learning Bayesian network parameters may use a combination of labeled and unlabeled data. Unfortunately, prior methods for learning from a combination of unlabeled and labeled data usually lead to inconsistent results. Sometimes such methods yield a more accurate Bayesian network classifier and sometimes such methods yield a less accurate Bayesian network classifier.

### SUMMARY OF THE INVENTION

A method is disclosed that yields more accurate Bayesian network classifiers when learning from unlabeled data in combination with labeled data. The present technique enable an increase in the accuracy of a statistically learned Bayesian network classifier when unlabeled data are available and reduces the likelihood of degrading the accuracy of the Bayesian network classifier when using unlabeled data.

A method according to the present teachings includes learning a set of parameters for a structure of a classifier using a set of labeled data only and learning a set of parameters for the given structure using the labeled data and a set of unlabeled data and then modifying the structure if the parameters based on the labeled and unlabeled data leads to less accuracy in the classifier in comparison to the parameters based on the labeled data only.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a Bayesian network learning system according to the present teachings;

FIG. 2 illustrates a method for generating a Bayesian network classifier according to the present technique;

FIG. 3 shows an example initial structure for a Bayesian network classifier;

FIG. 4 shows an example modified structure for a Bayesian network classifier.

### DETAILED DESCRIPTION

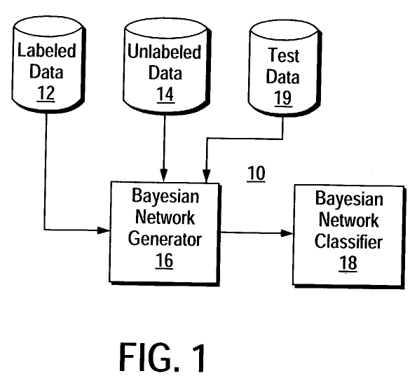

FIG. 1 shows a Bayesian network learning system 10 according to the present teachings. The learning system 10 includes a Bayesian network generator 16 that generates a Bayesian network classifier 18 in response to a set of labeled data 12 and a set of unlabeled data 14 and a set of test data 19.

The Bayesian network generator 16 generates the Bayesian network classifier 18 by determining a structure of nodes and arcs and then learning one set of parameters for the structure using only labeled data and learning another set of parameters for the structure using a combination of labeled and unlabeled data. The Bayesian network generator 16 modifies the structure if the parameters based on the combination of labeled and unlabeled data lead to less accuracy. The Bayesian network generator 16 uses the test data 19 to determine the accuracies.

The Bayesian network learning system 10 may be implemented in software that executes on a computer system.

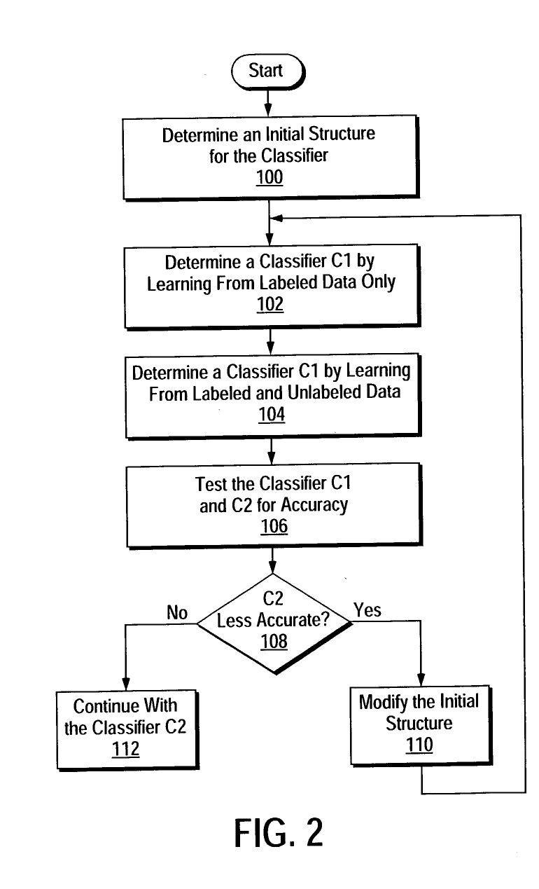

FIG. 2 illustrates a method for generating the Bayesian network classifier 18 in one embodiment. At step 100, the Bayesian network generator 16 determines an initial structure for the Bayesian network classifier 18. Any method may be used to determine the initial structure at step 100.

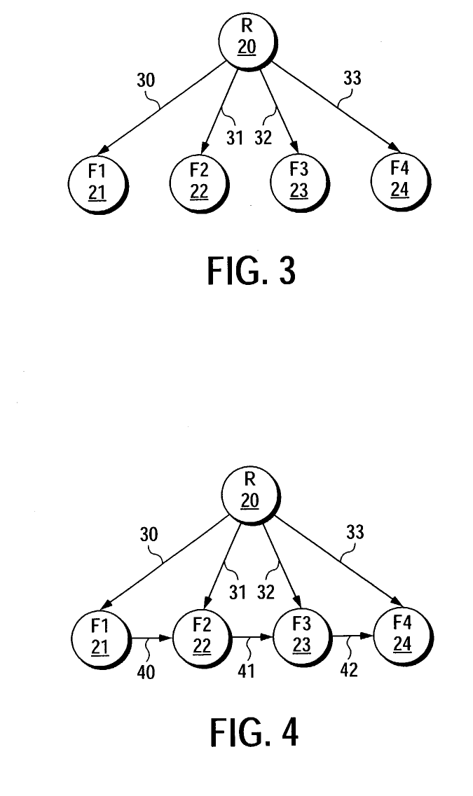

FIG. 3 shows an example initial structure for the Bayesian network classifier 18 from step 100. The initial structure of the Bayesian network classifier 18 in this example includes a set of nodes 20-24 and a set of interconnecting arcs 30-33. The node 20 is a parent node to the nodes 21-24. The node 20 corresponds to a result (R) variable for the Bayesian network classifier 18. The child nodes 21-24 respectively correspond to a set of features (F1-F4) that lead to the result R.

Each of the nodes 20-24 has an associated conditional probability table in the initial structure from step 100. Each conditional probability table is for holding a corresponding set of Bayesian network parameters. The following illustrates an example conditional probability table for the node 20 (priors given that the node 20 has no parents).

P (R = Y)
P (R = N)

The result R associated with the node 20 in this example is a binary result, i.e. Yes/No. The conditional probability table for the node 20 includes the probability that R=Yes (P(R=Y)) and the probability that R=No (P(R=N)).

The following illustrates an example conditional probability table for the node 21.

| | |
|---|---|
| P (F1 = Y\|R = Y) | P (F1 = N\|R = Y) |
| P (F1 = Y\|R = N) | P (F1 = N\|R = N) |

The feature F1 associated with the node 21 in this example is a binary value of Yes/No. The conditional probability table for the node 21 includes the probability that F1=Yes given that R=Yes (P(F1=Y|R=Y)) and the probability that F1=Yes given that R=No (P(F1=Y|R=N)) and the probability that F1=No given that R=Yes (P(F1=N|R=Y)) and the probability that F1=No given that R=No (P(F1=N|R=N)).

The following illustrates an example conditional probability table for the node 22 which is associated with a binary feature F2.

| | |
|---|---|
| P (F2 = Y\|R = Y) | P (F2 = N\|R = Y) |
| P (F2 = Y\|R = N) | P (F2 = N\|R = N) |

The conditional probability table for the node 22 includes the probability that F2=Yes given that R=Yes (P(F2=Y|R=Y)) and the probability that F2=Yes given that R=No (P(F2=Y|R=N)) and the probability that F2=No given that R=Yes (P(F2=N|R=Y)) and the probability that F2=No given that R=No (P(F2=N|R=N)).

The nodes 23-24 have similar arrangements for the probabilities associated with the features F3-F4, respectively.

At step 102, the Bayesian network generator 16 determines a classifier C1 by learning a set of parameters for the initial structure from step 100 using the labeled data 12 only.

The following is a set of example records (Record 1-4) of the labeled data 12.

| | F1 | F2 | F3 | F4 | R |
|---|---|---|---|---|---|
| Record 1 | Y | N | N | N | Y |
| Record 2 | Y | Y | Y | Y | N |
| Record 3 | Y | Y | N | Y | Y |
| Record 4 | N | N | Y | N | N |

The Bayesian network generator 16 determines the probabilities for the conditional probability tables of the nodes 20-24 at step 102 by tallying the information contained in the records 1-4 and using the tallies to compute probabilities. For example, the result R tallies from Records 1-4 are Yes=2 and No=2, thereby yielding P(R=Y)=2/4 and P(R=N)=2/4 for the priors of the node 20.

The Records 1-4 yield the following probabilities for the conditional probability table of the node 21.

P (F1 = Y|R = Y) = 2/2
P (F1 = Y|R = N) = 1/2
P (F1 = N|R = Y) = 0/2
P (F1 = N|R = N) = 1/2

The Records 1-4 yield the following probabilities for the conditional probability table of the node 22.

P (F2 = Y|R = Y) = 1/2
P (F2 = Y|R = N) = 1/2
P (F2 = N|R = Y) = 1/2
P (F2 = N|R = N) = 1/2

The probability values in the conditional probability tables for the nodes 23-24 may be determined in a similar manner.

At step 104, the Bayesian network generator 16 determines a classifier C2 by learning a set of parameters for the initial structure from step 100 using both the labeled data 12 and the unlabeled data 14. Any known technique may be employed at step 104 to learn the Bayesian network parameters for the nodes 20-24 from the combination of the labeled data 12 and the unlabeled data 14. For example, a technique based on an expectation maximization (EM) method may be employed at step 104.

The unlabeled data 14 may be arranged as a set of records such as the records 1-4 above but without values for the result variable of the records. In addition, the unlabeled data records may includes only a subset of values for the features F1-F4. There may be many more records in the unlabeled data 14 in comparison to the labeled data 12.

A technique for learning from the unlabeled data 14 may include an initial labeling of the records of the unlabeled data 14 by classifying the available features. The label assigned to an unlabeled data record may be probabilities associated with a classification result for the unlabeled data record. After assigning labels to the unlabeled data records the parameters of the classifier C2 are relearned with the unlabeled data records now labeled and treated as if they were labeled data. The process of labeling the unlabeled data may then be repeated using the new parameters of the classifier C2 in an iterative manner.

At step 106, the Bayesian network generator 16 tests the classifiers C1 and C2 to determine which one is the most accurate. The Bayesian network generator 16 performs step 106 using the test data 19. The test data 19 is labeled data. It is preferable that the test data not be the same labeled data that was used in steps 102-104 to generate the classifiers C1 and C2.

At step 108, if the classifier C2 is less accurate than the classifier C1 then at step 110 the Bayesian network generator 16 modifies the initial structure from step 100 that formed the basis of the classifiers C1 and C2. Step 110 may involve generating a slightly richer Bayesian network structure. Examples of making the structure richer include modifications include adding nodes, adding edges, constraining structures to a particular superset, etc.

FIG. 4 shows an example modified structure for the Bayesian network classifier 18 from step 110. This example modification adds a new set of arcs 40-42 to the initial structure shown in FIG. 3.

The Bayesian network generator 16 may iteratively repeat steps 102-110 to generate and test pairs of classifiers C1 and C2 which are based on successively modified structures.

At step 108, if the classifier C2 is not less accurate than the classifier C1 then at step 112 the learning process on the classifier C2 using the current structure continues.

A variety of known learning methods may be used for processing labeled and unlabeled records at step 104. In addition, a variety of known methods may be used for structure modifications at step 108. As a consequence, the present technique is readily adaptable to a wide variety of known methods for learning Bayesian network classifiers.

The present technique for learning Bayesian network classifiers benefits from observations that learning from unlabeled data in prior methods can degrade the accuracy of a classifier. Given this observation, if learning from unlabeled data degrades a classifier then it may be inferred that the classifier structure does not match the structure of the underlying reality. The observation that additional data, albeit unlabeled, degrades classification performance may be counter-intuitive but may be nevertheless demonstrated by experimentation and theoretical analysis.

The present technique may be employed when exploring a space of Bayesian network structures for a particular classification application. In such activities, the effect of processing a particular batch of unlabeled data may be used to decide whether to keep processing the training data to improve the parameters in the conditional probability tables of the current structure or alternatively to backtrack to a different possibly richer structure and start over.

The present systematic technique for learning from unlabeled data in combination with labeled data may yield more accurate Bayesian network classifiers. These technique may be used to increase the accuracy of statistically learned Bayesian network classifiers when unlabeled data are available as is frequently the case. These technique also reduce the likelihood of degrading the resulting Bayesian network classifier when using unlabeled data as is common in prior technique.

The present systematic technique provides a systematic method to leverage a moderate number of labeled data in the presence of a large number of unlabeled data to reach a more accurate classifier. As such, these technique advance the state of the art in the field of semi-supervised learning and thereby increases the field of applicability of Bayesian network classifiers to circumstances where a moderate amount of labeled data are available.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for generating a classifier, comprising the steps of:
learning a set of parameters for a structure of the classifier using a set of labeled data;
learning a set of parameters for the structure using the labeled data and a set of unlabeled data;
modifying the structure if the parameters based on the labeled and unlabeled data leads to less accuracy in the classifier in comparison to the parameters based on the labeled data only.

2. The method of claim 1, wherein the step of learning a set of parameters for a structure of the classifier using a set of labeled data comprises the step of learning the parameters in response to a set of labeled records each comprising a value for each of a set of features and a corresponding label.

3. The method of claim 1, wherein the step of learning a set of parameters for the structure using the labeled data and a set of unlabeled data comprises the step of learning the parameters in response to a set of labeled records each comprising a value for each of a set of features and a corresponding label and a set of unlabeled records each comprising a value for a subset of the features.

4. The method of claim 1, wherein the step of modifying the structure if the parameters based on the labeled and unlabeled data leads to less accuracy in the classifier in comparison to the parameters based on the labeled data only comprises the steps of:
generating a first classifier based on the structure using the parameters derived from the labeled data only;
generating a second classifier based on the structure using the parameters derived from the labeled data and the unlabeled data;
determining an accuracy of the first classifier and an accuracy of a second classifier;
modifying the structure if the accuracy of the second classifier is less than the accuracy of the first classifier.

5. The method of claim 4, further comprising the step of learning the parameters for the second classifier using a set of additional data if the accuracy of the second classifier is not less than the accuracy of the first classifier.

6. The method of claim 5, wherein the step of determining an accuracy comprises the step of determining the accuracy using a set of labeled test data.

7. A method for generating a classifier, comprising the steps of:
generating an initial structure for the classifier;
generating a first classifier by learning a set of parameters for the initial structure in response to a set of labeled data;
determining a second classifier by learning a set of parameters for the initial structure in response to the labeled data and a set of unlabeled data;
modifying the initial structure for the classifier if the second classifier is less accurate than the first classifier.

8. The method of claim 7, further comprising the step of determining whether the second classifier is less accurate by testing the first and second classifiers using a set of test data.

9. The method of claim 8, wherein the step of testing the first and second classifiers using a set of test data comprise the step of testing the first and second classifiers using a set of labeled test data.

10. The method of claim 7, further comprising the step of learning the parameters for the second classifier using a set of additional data if the accuracy of the second classifier is not less than the accuracy of the first classifier.

11. A Bayesian network learning system, comprising:
a set of labeled data;
a set of unlabeled data;
Bayesian network generator that determines a set of parameters for a structure of a classifier in response to the labeled data and a set of parameters for the structure in response to a combination of the labeled data and the unlabeled data and that modifies the structure if the parameters based on the labeled and the unlabeled data leads to less accuracy in the classifier in comparison to the parameters based on the labeled data only.

12. The Bayesian network learning system of claim 11, wherein the labeled data includes a set of labeled records each comprising a value for each of a set of features and a corresponding result to be determined by the classifier.

13. The Bayesian network learning system of claim 12, wherein the unlabeled data includes a set of unlabeled records each comprising a value for a subset of the features.

14. The Bayesian network learning system of claim 11, wherein the Bayesian network generator determines a first classifier based on the structure using the parameters derived from the labeled data only and determines a second classifier based on the structure using the parameters derived from the labeled data and the unlabeled data and modifies the structure if an accuracy of the second classifier is less than an accuracy of the first classifier.

15. The Bayesian network learning system of claim 14, wherein the Bayesian network generator determines the parameters for the second classifier using a set of additional data if the accuracy of the second classifier is not less than the accuracy of the first classifier.

16. The Bayesian network learning system of claim 15, further comprising a set of labeled test data.

17. The Bayesian network learning system of claim 16, wherein the Bayesian network generator determines the accuracy in response to the labeled test data.
